(19) United States
(12) Patent Application Publication
(10) Pub. No.: US 2016/0247169 A1
(43) Pub. Date: Aug. 25, 2016

(54) APPARATUS AND METHODS TO PREDICT AGE DEMOGRAPHICS OF CONSUMERS

(71) Applicant: The Nielsen Company (US), LLC, Schaumburg, IL (US)

(72) Inventors: Michael Sheppard, Brooklyn, NY (US); Matthew Reid, Alameda, CA (US); Caroline McClave, Lyme, NH (US); Sarah Elizabeth Anderson, Ithaca, NY (US); Alejandro Terrazas, Santa Cruz, CA (US); Jonathan Sullivan, Hurricane, UT (US)

(21) Appl. No.: 14/627,510

(22) Filed: Feb. 20, 2015

(51) Int. Cl. G06Q 30/02; G06N 7/00

(52) U.S. Cl. CPC G06Q 30/0201; G06N 7/005

(57) ABSTRACT

Apparatus and methods to predict age demographics of consumers are disclosed. An example disclosed method includes obtaining names of consumers associated with a business establishment. The example method also includes determining age probabilities of the consumers based on different ones of the names of the consumers. The example method further includes generating an age distribution of the consumers based on the age probabilities.

### FIELD OF THE DISCLOSURE

This disclosure relates generally to consumer marketing research and, more particularly, to apparatus and methods to predict age demographics of consumers.

### BACKGROUND

In some circumstances, when consumers purchase goods and/or services from and/or engage in other transactions with various business establishments the consumers may provide their name as part of the transaction. For example, many businesses such as restaurants, coffee shops, hair salons, etc., take the name of the customers when they make reservations or place orders to enable the effective management of all customers and their associated requests. Further, businesses may otherwise have access to the names of consumers based on the names being associated with corresponding accounts (e.g., an online shopping account, a credit card, etc.) and/or otherwise provided by the consumers.

### BRIEF DESCRIPTION OF THE DRAWINGS

FIG. 1 is a schematic illustration of an example environment in which the teachings disclosed herein may be implemented.

FIG. 2 is a block diagram of an example implementation of the example data processing facility of FIG. 1.

FIG. 3 is a table illustrating fictitious values for the number of people born with the names of Matt, Mike, and Sarah between 1940 and 2009 and the probability of ages of such people based on their names.

FIG. 4 is a chart graphically illustrating the number of people born with the names as represented in the table of FIG. 3.

FIG. 5 is a chart graphically illustrating the probability of ages of the people represented in the table of FIG. 3.

FIG. 6 is a table illustrating fictitious values of the number of consumers transacting business at an example store with names corresponding to those represented in the table of FIG. 3.

FIG. 7 is a table illustrating example age demographics of the example store associated with the table of FIG. 6.

FIG. 8 is a chart graphically illustrating an example aggregated age distribution of the example store associated with the tables of FIGS. 6 and 7.

FIGS. 9-12 are flowcharts representative of example machine readable instructions that may be executed to implement the example data processing facility of FIGS. 1 and/or 2.

FIG. 13 is a block diagram of an example processor platform capable of executing the example machine readable instructions of FIGS. 9-12 to implement the example data processing facility of FIGS. 1 and/or 2.

### DETAILED DESCRIPTION

The Social Security Administration (SSA) of the United States maintains a database of the first names given to each baby born in the country for each year and the corresponding number of babies receiving the same name in each year. The SSA has made this data publicly available for every year going back to 1880. As this covers more than 130 years, every person (with some limited exceptions) now living that was born in the United States is represented in the SSA database. Thus, for any particular person born in the United States after 1880, the number of people born with the same name as that person can be determined. Likewise, the number of people born any other year since 1880 that were given the same name can also be determined.

In addition to the nationally-based SSA data, most of the states provide similar information specific to each state. Thus, the number of people born in a particular state with a particular name can be determined for any given year where records are available. Other countries and/or other regions maintain similar information providing the number of people born in such locations that were given the same name at birth.

A review of the birth records provided by the SSA reveals that the popularity of certain names change over time such that more people with a given name may be born in one year than another year. For example, the female name “Gertrude” reached a peak of popularity in 1917 with just over 6300 babies born in the United States with that name. Approximately one tenth that amount (612) were named Gertrude in 1950 and by 1975 less than 50 babies born in the Unites States were named Gertrude. In contrast, the name “Brittany” was not used as a baby name until the 1960s with 332 babies named Brittany by 1975. Over the next decade, Brittany became very popular peaking with nearly 38,000 babies given the name in 1989. This number does not even include variations in the spelling of the name (e.g., Bryttnee, Bryttany, Brytni, Brittney, Britney, Britianee, Britanny, Bryttani, etc.) adding thousands more to those born that year. In fact, in 1989 approximately 1 in every 50 baby girls was named some variant of Brittany. The rapid rise in the use of Brittany was followed by a similarly rapid decline in use with less than 1000 babies being given the name of Brittany by 2007. Thus, different names may have periods of heightened use at certain times and less use at other times throughout history.

Although the use of a name varies over time the relative popularity of any particular name depends on the frequency of use of other names at the same time. For example, although the name Gertrude was most popular in 1917 (relative to its use at other times), the name only accounted for less than half a percent of all female babies born that year. By contrast, at its peak in 1989, the name Brittany (when combined with its variants) accounted for more than two percent of all females or approximately 1 in every 50 baby girls. This may be put further into perspective when compared with the name “Mary,” which was given to nearly five percent (1 in 20) of baby girls during most of the 1920s and 30s and remained popular for some time thereafter but has since dropped in popularity to less than two tenths of a percent of all baby girl names.

Baby or birth names with periods of relatively high use and periods of relatively low use result in a concentration of people with such names having the same or similar age. For example, while there may be some older and younger, the vast majority of people named Brittany were born within five to ten years of its peak use in 1989. Thus, without knowing more about a person than that her name is Brittany, there is a relatively high probability that she will be between 20 and 30 years old in 2015. By 2030, most women named Brittany will be between 35 and 45 years old (unless the name becomes more popular again in that time period)

Of course, some names maintain a relatively consistent usage over time such that people with such a name do not exhibit a narrow age distribution as with Brittany. For example, between 1910 and 2010, there was between approximately 10 and 20 thousand babies born every year that were named Elizabeth (typically around 0.6 and 1 percent of all baby girls born in any given year). Thus, without knowing more about a person than that her name is Elizabeth, the probability that she was born in any given year is approximately equivalent with the probability for any other year.

Independent of the number of babies born in any given year with a particular name, the probability that a person with a particular name is born in a particular year decreases as the particular year of interest moves further back in time because people do not live forever. For example, although 1917 was the year that the use of Gertrude was at its peak, babies born that year would be 98 years old in 2015. Actuarial data has been calculated based on death records to determine the percentage of people born in a given year who are still alive at some later point in time. For example, over 98 percent of people born in the last 20 years (aged 20 or under) are still alive. The percentage drops to about 90 percent for people born 50 years ago with the percentage dropping at an accelerated rate to just a few percent for people born 100 years ago. Thus, of the approximately 6300 Gertrudes born in 1917, it is likely that only a few hundred will still be alive in 2015.

Using birth records provided by the SSA (or other sources) and death records to determine the life expectancy of people born in any given year, the probability of the age of people with a known name can be calculated. Example systems and methods disclosed herein use such information to estimate the age demographics of consumers associated with one or more business establishments based on the first names of such consumers. In some examples, the names of consumers are obtained directly by the businesses as part of an order management system in which the consumers provide their name to be tied to a product or service they have requested. For example, after placing orders at a take-out restaurant, customers may provide their names to be called up once their orders are filled. Similar concepts are often implemented in many other types of businesses that involve consumers making reservations (e.g., at sit-down restaurants, hotels, etc.) or arranging appointments (e.g., at hair salons, car mechanics, etc.). Some businesses may acquire the name of consumers based on consumer input information (e.g., as part of the creation of an account or an online user login, when providing their address to ship goods, when filling out a form, etc.). Additionally, many businesses may obtain the names of consumers indirectly based on the names associated with the credit cards used by consumers to make purchases. Thus, there are a variety of ways that names of consumers can be collected and/or determined by businesses.

In some examples, all the names of consumers associated with a business are collected and analyzed to estimate the age demographics of the consumers for the business. In particular, in some examples, the probability of different ages for each separate name is calculated based on the birth name data and actuarial life tables. This data is then weighted based on the frequency of occurrence of each consumer name identified to generate a consumer age distribution for the business. That is, the age distribution provides the probability of any particular consumer of the business being a particular age. In some examples, the distribution can be divided by year. In other examples, the demographics distribution is divided into buckets or ranges of two or more years (e.g., distribution based on the decade in which consumers are born).

In some examples, the business corresponds to a single location (e.g., a particular store). In other examples, the business may be an establishment having multiple physical locations (e.g., a chain of stores). Thus, in some examples, the age distribution may correspond to a particular store, a group of stores (e.g., in a particular state or other region), or all stores associated with the business establishment. In some examples, different distributions are generated for different locations or regions to identify any differences in the age distribution associated with each location or region.

In some examples, in addition to the name and resulting estimation of age of consumers for a business, other purchasing data is obtained and analyzed to gain further insights into the demographic makeup of the consumers. In some examples, consumer purchasing data includes an identification of the products purchased. With this information, various age distributions can be calculated. For example, if a consumer enters a Starbucks™ coffee shop and orders a double nonfat latte, an age distribution for all consumers that purchase that same product may be generated by analyzing the names of all consumers that purchased a double nonfat latte. In other examples, an age distribution may be calculated for products associated with a particular brand. In other examples, the age distribution of a higher order product type or category (e.g., coffee products) may be calculated. In other examples, an age distribution may be calculated for people associated with a group to which the product belongs (e.g., premium non-alcoholic beverage drinkers).

In some examples, product-specific age distributions are compared to the overall distribution of the business and/or compared to other age distributions associated with different products, product categories, or marketing segments to identify any differences in demographics. For example, the age distribution demographics for a drip coffee compared with a distribution for a Frappuccino™ may reveal that the largest portion of people purchasing drip coffee are between 65 and 75 whereas the largest portion of people purchasing Frappuccinos™ are between 20 and 30. Such a comparison would reveal that preferences for drip coffee skew older whereas preferences for Frappuccino™ skew younger.

In addition to product information, in some examples, purchasing data includes timing information corresponding to when a particular consumer entered a transaction with the business (e.g., time of the day, day of the week, etc.). As a result, in some examples, age distributions can be generated based on names of consumers placing orders at different times of the day to identify how much variation in the age of the consumers there is throughout the day (e.g., whether “early bird specials” attract more older people while “2 a.m. bar closings” are associated with younger people). Other types of age distributions based on other factors may also be generated as described more fully below.

In some examples, age distributions for business establishments are monitored over time to identify any trends. In some such examples, age distributions may be generated (or updated) for comparison on a relatively regular basis (e.g., once a day, once a week, once a month, etc.) depending on the number of consumers during any given period. In this manner, any trends in age distribution may be tracked over time to identify any basis for changes in the age distributions (e.g., particular age groups respond more to certain advertising and/or promotional campaigns). Additionally or alternatively, in some examples, age distributions may be monitored for comparison over extended periods of time (e.g., one or more years, a decade, a generations (e.g., 25 years)). Trends over such extended periods of times can be analyzed to determine, for example, the level of brand loyalty of consumers as they age, the generational appeal of the business and/or products of the business, etc.

Further, any of the above aspects may be combined to generate complex and tailored age distributions specific to the needs and/or interests of business establishment(s) not previously possible. That is, the examples disclosed herein may analyze the names of potentially thousands (if not millions) of consumers over short time spans or extended periods of many years to predict an overall age distribution and/or parse the data into a variety of timing-based, geographically-based, product-based, payment-method-based, and/or gender-based distributions. Further still, some example methods include analytics to identify and/or group consumers having different but related names such as, for example, nick-names, short forms of names, and/or alternate spellings for more accurate assessments. Additionally, in some examples, particular age groups may be excluded if such age groups do not fall into an expected age range for consumers such that changes in the popularity of birth names for excluded individuals does not affect the predicted age distributions of the target consumer base.

An example disclosed method includes obtaining names of consumers associated with a business establishment. The example method also includes determining age probabilities of the consumers based on different ones of the names of the consumers. The example method further includes generating an age distribution of the consumers based on the age probabilities.

An example apparatus disclosed herein includes an age probability calculator to calculate probabilities of ages of consumers associated with a business establishment. The probabilities of ages determined based on names of the consumers. The example apparatus also includes an age distribution generator to generate an age distribution of the consumers based on the probabilities of ages of the consumers.

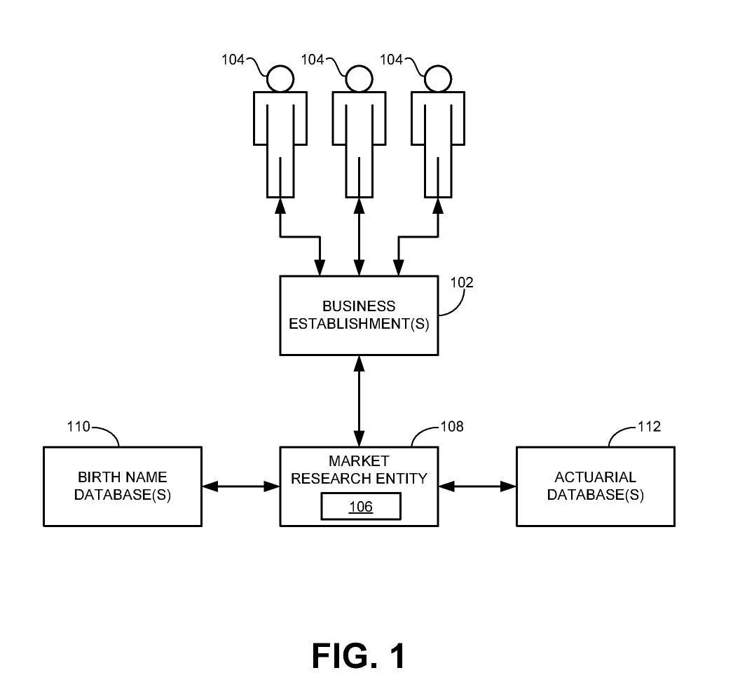

FIG. 1 is a schematic illustration of an example environment in which the teachings disclosed herein may be implemented. The example environment includes one or more business establishment(s) 102 that provide goods or services to consumers 104. In the illustrated example, the business establishment(s) 102 receive and/or otherwise have access to the first or given names of the consumers 104. In some examples, consumers 104 may provide their names at the time of entering into a transaction with the business establishment(s) 102. For example, the business establishment(s) may be restaurants, coffee shops, etc. that take the names of consumers 104 as they place orders so that the business establishment(s) can tie the orders to the corresponding consumers 104 once their orders are filled. In other examples, the business establishment(s) 102 may take the name of a customer making a reservation (e.g., for a hotel or restaurant) or an appointment (e.g., at a beauty parlor or mechanic) with the business establishment(s) 102. In some examples, the business establishment(s) may establish an account with each consumer 104 by which the names of the consumers 104 can be stored and subsequently associated with future transactions. For example, the business establishment(s) 102 may sell goods or services online that require consumers to enter their name as part of a user login or checkout procedure. Additionally or alternatively, in some examples, consumers 104 may pay for goods or services using credit cards and the names associated with the credit card accounts may be used to tie the names of the consumers 104 to their transactions.

In addition to receiving the names of the consumers 104, in some examples, the business establishment(s) 102 receive and/or otherwise have access to other information about the consumers 104 such as their age, gender, location of residence, location of birth, and/or other demographic data. Furthermore, in some examples, the business establishment(s) 102 receive and/or otherwise have access to purchasing data indicative of the circumstances of transactions entered into between the consumers 104 and the business establishment(s) 102. In some examples, the purchasing data includes an identification of the goods or services purchased, a quantity purchased, a timing (e.g., time of day, day of week) of the transaction(s), an amount paid, a method of payment (e.g., cash, check, credit card, etc.), a location of the consumers 104, the particular business establishment 102 involved in the transaction(s) (e.g., the location and/or name of the business), etc. In some examples, the business establishment(s) 102 generate such purchasing data when transactions are entered into. In other examples, at least some of the purchasing data is provided via third party entities involved in the transactions (e.g., credit card companies). For purposes of convenience, the names of the consumers 104, the other demographic data, and the purchasing data are collectively referred to herein as consumer data.

In some examples, the business establishment(s) 102 provide the consumer data to a data processing facility 106 of a market research entity 108. In some examples, the data processing facility 106 collects and/or aggregates such data from multiple different business establishments 102. In the illustrated example, the market research entity 108 generates reports indicative of the age demographics of the consumers 104 patronizing the business establishment(s) 102 based on the names of the consumers 104. More particularly, in some examples, the market research entity 108 accesses historical birth name database(s) 110 and actuarial database(s) 112 to analyze the names of the consumers 104 to estimate the age of each consumer 104 and, thus, predict an overall age distribution of all consumers 104 associated with the business establishment(s) 102 and/or a subset of the consumers 104 identified by one or more factors associated with the consumer transactions (e.g., type of product, method of payment, location, timing, etc.).

In some examples, the historical birth name database(s) 110 are publicly available databases provided by government entities. For example, the SSA collects data on the name of every child born within the United States that is registered for a social security card. The SSA provides a database of the number of males and females born each year associated with every given birth name. Individual states within the United States also provide similar information for babies born within each state. Similar data may be available from the governments of other countries as well. In some examples, the actuarial database(s) 112 are also publicly available databases provided by government entities. For example, based on death records and/or periodic census data, the National Center for Health Statistics of the Center publishes life tables indicating the proportion of people born in a given year (or decade) that are still alive in some other given year at a later point in time.

Using the birth name database(s) 110 and the actuarial database(s) 112, the market research entity 108 can calculate the probability that a consumer 104 with a given name is a particular age. In some examples, the market research entity 108 may generate a probability distribution of age for each name of each consumer 104. In some such examples, as detailed more fully below, the probability of ages of individuals with particular names may be combined to generate a general or aggregated age distribution representative of the age demographics of the consumers 104 associated with the business establishment(s) 102.

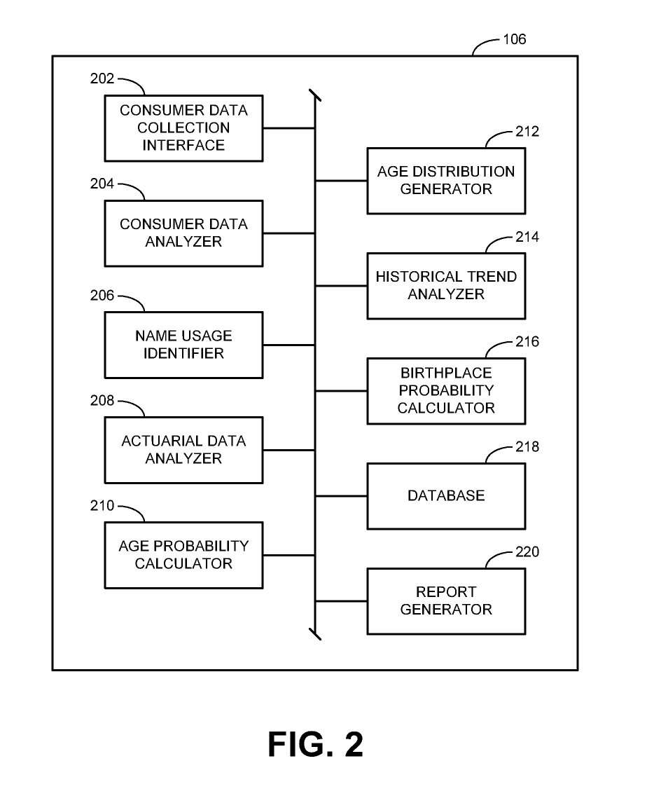

FIG. 2 is a block diagram of an example implementation of the example data processing facility 106 of FIG. 1. The example data processing facility 106 includes an example consumer data collection interface 202, an example consumer data analyzer 204, an example name usage identifier 206, an example actuarial data analyzer 208, an example age probability calculator 210, an example age distribution generator 212, an example historical trend analyzer 214, an example birthplace probability calculator 216, an example database 218, and an example report generator 220.

In the illustrated example of FIG. 2, the data processing facility 106 is provided with the consumer data collection interface 202 to receive consumer data from one or more business establishment(s) 102. In some examples, the consumer data includes the first names of consumers 104 associated with the business establishment(s) 102. Additionally, in some examples, the consumer data includes other demographic information about the consumers (e.g., their age, gender, location of residence, location of birth, etc.). In some examples, the consumer data includes purchasing data corresponding to the circumstances of purchases made by the consumers 104 (e.g., type(s) of goods or services purchased, timing of purchase, method of payment, location, etc.). In some examples, the consumer data is stored in the example database 218 for subsequent analysis.

In some examples, consumer data is received by the consumer data collection interface 202 from a single business establishment 102. In other examples, the consumer data is received by the consumer data collection interface 202 from multiple different business establishments 102. In some such examples, the consumer data is aggregated for the multiple business establishments. In other examples, the consumer data from separate business establishments is kept separate.

In the illustrated example of FIG. 2, the data processing facility 106 is provided with the consumer data analyzer 204 to analyze and/or parse the consumer data to identify relevant information for subsequent analysis. For example, the consumer data analyzer 204 may identify the first names of the consumers 104 for which consumer data was received. Further, in some examples, the consumer data analyzer 204 may identify purchasing data associated with purchases or other transactions entered into by the consumers 104. For example, the consumer data analyzer 204 may identify the product(s) or service(s) purchased by the consumers 104, the associated type or category of product(s) or service(s) purchased, the brands of the products purchased, the method of payment, the business establishment 102 where the purchase was made (e.g., the name of the business establishment), the type of business establishment where the purchase was made (e.g., restaurant, beauty salon, hotel, department store, etc.), the location of the purchase (e.g., address of the business establishment, address of the consumer 104 (e.g., for online purchases)), the timing (e.g., time of day, day of week) of the purchase, etc.

In some examples, the consumer data analyzer 204 associates the identified purchasing data with the corresponding consumers 104. In some examples, a particular consumer 104 may enter into multiple transactions with the same business establishment 102 at different times (e.g., a repeat customer). In some examples, the unique identity of the particular consumer 104 may be tracked across the multiple transactions (e.g., where the consumer 104 is associated with a particular account maintained by the business establishment 102). In some such examples, the consumer data analyzer 204 associates the identified purchasing data for the multiple transactions with the particular consumer 104 and the first name of the corresponding consumer 104. In other examples, the only identification for particular consumers is their first name (e.g., obtained to manage received orders at a coffee shop). In such examples, there is no way of knowing whether orders from a ‘David’ at two different points in time are from the same consumer 104 (e.g., a repeat customer) or two different consumers 104 with the same name. Accordingly, in some examples, the consumer data analyzer 204 treats every transaction separately such that the identified purchasing data is associated only with the name of the consumer 104 associated with the particular transaction from which the purchasing data was identified. That is, a repeat customer would be represented in the data multiple times corresponding to each separate transaction of the customer. In other examples, the consumer data analyzer 204 aggregates or associates all of the identified purchasing data for all consumers 104 with the same name regardless of whether the separate transactions correspond to one or more consumers 104 with that name.

In the illustrated example of FIG. 2, the data processing facility 106 is provided with the example name usage identifier 206 to identify the historical usage of a particular name (e.g., usage in naming babies) of one or more of the consumers 104. In some examples, the name usage identifier 206 retrieves and/or performs a lookup of the particular name of interest from the birth name database(s) 110 for every year where records are available. That is, in some examples, the name usage identifier 206 determines the number of people born in each year that were given the same name at birth. In some examples, the name usage identifier 206 may include different spellings, variants, short forms, long forms, and/or nicknames associated with the particular name. That is, in some examples, two given names are considered the “same” even when there is a difference in spelling (e.g., John and Jon). However, in other examples, any difference in spelling may be considered a different name. For example, if consumers 104 provide the spelling of their names, the particular spelling may be used as distinct from other spellings. By contrast, if the spelling is not given (e.g., the consumers 104 verbally state their names), alternate spellings may be combined together. In some examples, the alternate spellings are determined fuzzy matching or double metaphone algorithms. Further, in some examples, different names that are short forms or nicknames for other names may all be considered the “same” (e.g., Robert, Rob, Robbie, Robby, and Bob). Thus, the particular probability of ages of people with a particular name may depend upon how the name (including any variants) is treated during the analysis.

The number of people born each year over time with the same given name as determined by the name usage identifier 206 can be used to generate a plot or distribution of the relative popularity (e.g., frequency of use) of the name over time. However, this is not an accurate distribution of the age of people with the given name because an increasing portion of the people born further back in time in any given year will likely no longer be alive. Accordingly, in the illustrated example of FIG. 2, the data processing facility 106 is provided with the actuarial data analyzer 208 to take into account deaths over time based on an analysis of actuarial life tables obtained from the actuarial database(s) 112. In some examples, the actuarial data analyzer 208 determines the percentage of people born in each year for which the birth names were analyzed that are still alive. In some examples, the actuarial data analyzer 208 determines such percentages for each year independent of the particular name being analyzed on the assumption that people's names do not impact their life expectancy. More particularly, while different names may be correlated with different ethnicities and/or socio-economic backgrounds that may correlate with longevity, in some examples, these factors are considered negligible. However, there are actuarial tables delineated by race, ethnicity, geographic location (e.g., by state), among a variety of other factors (e.g., occupation, activity (smoker vs. non-smoker), etc.) Accordingly, in some examples, where the race, ethnicity, location and/or other factors associated with the consumers 104 are known or can be confidently assumed, actuarial tables based on such factors may be employed for more accurate predictions of the ages of the consumers 104. Further, in some examples, the actuarial data analyzer 208 may determine separate percentages of survivorship by year of birth for males and females as gender has a significant role in the life expectancy of individuals.

With the number of people born each year with a particular name determined by the name usage identifier 206 and the percentage of people born each year that are still alive determined by the actuarial data analyzer 208, the example age probability calculator 210 calculates the probability of ages of people with the particular name. In some examples, the age probability calculator 210 determines the probability of ages by multiplying the percentage of people born each year that are still alive (based on actuarial data) by the total number of people born in the corresponding year with the particular name of interest (based on birth name data). This calculation provides an estimate of the actual number of people born each year with the particular name that are still alive. In some examples, the age probability calculator 210 divides the estimated number of such people born each year that are still alive by the cumulative total number of people with the particular name born throughout time that are still alive. This ratio can be expressed as a percentage representative of the probability that a person with the particular name is born in any given year. In some examples, the age probability calculator 210 plots these percentages or probabilities for each year to generate an age probability distribution for the particular name being analyzed. In some examples, the age probability calculator 210 combines multiple years into a single range for purposes of the analysis (e.g., 5 years, 10 years, etc.).

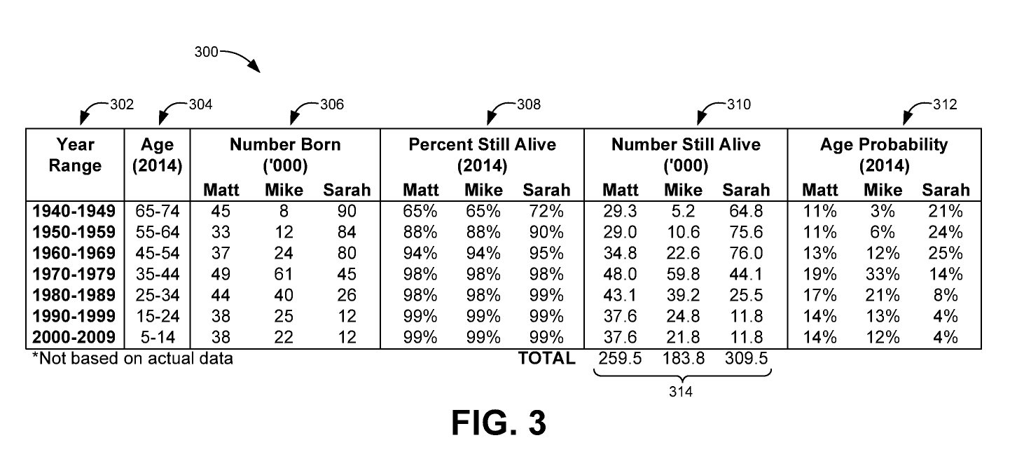

A specific example of the generation of name-specific probabilities for ages of different names is shown in illustrated examples FIGS. 3-6. FIG. 3 illustrates a table 300 of fictitious data representative of the number of people born, the number still alive, and the resulting probability of ages of people with the given names of Matt, Mike, and Sarah. For purposes of simplicity and explanation, as shown in the illustrated example, the table 300 includes a year range column 302 indicating the year ranges for which the data represents corresponding to decades from 1940 through 2009. Further, the example table 300 includes an age column 304 indicating the corresponding age range for the people born in each decade as of the year 2014.

The example table 300 includes a number born column 306 indicating the number of people born (in the thousands) during each decade that were named each of the three names. In some examples, the data represented in the number born column 306 is determined by the name usage identifier 206 as described above.

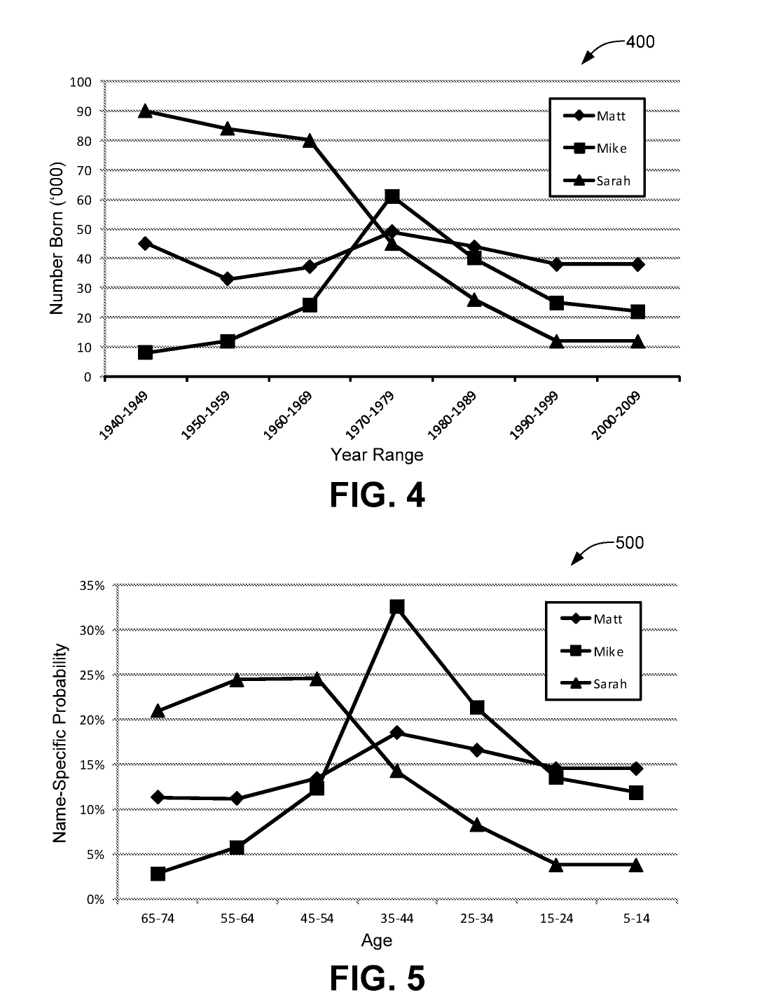

An example plot 400 of the number of people born as represented in column 306 of the table 300 of FIG. 3 is illustrated in FIG. 4. As indicated above, the data used in this example is fictitious for purposes of explanation and is not intended to reflect the actual number of people given the names of Matt, Mike, or Sarah. As shown in the plot 400 of FIG. 4, the relative popularity (e.g., frequency of use) of the name Sarah is much higher in the past (over 80,000 in each decade between 1940 and 1969) than in later years (below 15,000 in the decades since 1990). By contrast, the frequency of use of the name Mike over the same period represented in the illustrated example is relatively constant or smooth over time (between 33,000 and 49,000). Further, the name of Matt, as represented in the illustrated example, is characterized by a spike in usage during the 1970s with less usage both before and after that period.

Returning to FIG. 3, the example table 300 includes a percent still alive column 308 indicating the estimated number of people born in each decade that are still alive as of 2014. In some examples, such data is determined by the actuarial data analyzer 208 based on death records and/or other actuarial data obtained from the actuarial database(s) 112. As shown in the illustrated example, the percentage of those born in each decade named either Matt or Mike is the same because it is assumed that mortality rates are not affected by the name of a person. The percent still alive for people named Sarah in the illustrated example is slightly different to represent the difference between the mortality rates of men (Mike and Matt) and women (Sarah). As with the number born column 306, the values included in the percent still alive column 308 are not based on actual data.

The example table 300 of FIG. 3 further includes a number still alive column 310 to indicate the number of people (in the thousands) born in each decade that are still alive as of 2014. In some examples, the data represented in the number still alive column 310 is calculated by the age probability calculator 210 and is determined by multiplying the corresponding values in each of the number born column 306 and the percent still alive column 308. For example, based on the data represented in the illustrated example, 45,000 people were born named Mike in the 1940s, which once multiplied by the 65% still expected to be alive results in an estimated 29,300 still alive as of 2014.

As shown in the illustrated example, the table 300 includes an age probability column 312 to indicate the probability of a person having the name of any of Matt, Mike, or Sarah and being a particular age (e.g., born in a particular decade). In the illustrated example, the age probability calculator 210 calculates the data represented in the age probability column 312 by dividing the number of people still alive with a particular name (represented in number still alive column 310) by the total number of people living with the same name (indicated by the totals 314 below the number still alive column 310). For example, the total number of people named Mike that are living as of 2014 based on the illustrated example (which excludes any Mike born before 1940 or after 2009) is 259,500. Thus, the 29,300 Mikes born in the 1940s account for approximately 11% (29,300/259,500) of all people named Mike that are still living.

An example plot or distribution 500 of the name-specific probabilities of ages of people born with each of the names of Matt, Mike, and Sarah as represented in column 312 of the table 300 of FIG. 3 is illustrated in FIG. 5. As shown by a comparison of the plot 400 of FIG. 4 with the plot 500 of FIG. 5, although the highest number of people with the name of Sarah born in any decade was in the 1940s (aged 65-74 in 2014), they account for less than either of the two following decades because a smaller percentage of people born in the 1940s are still living relative to those born later reducing the total number still alive from the 1940s relative to the later decades. However, because the number born in the early decades (1940-1969) was so high relative to later in time, each of the three decades corresponds to between 20% and 25% of all people named Sarah that are still alive as of 2014. Thus, approximately 70% of all people named Sarah that are still alive in 2014 in the illustrated example are between the ages of 45 and 74.

As shown in the illustrated example plot 500 of FIG. 5, the spike of people named Mike in the 1970s results in a relatively high probability (33%) that any particular person named Mike will be born during that decade. That is, based on the data provided in this example, approximately 1 in 3 people named Mike living as of 2014 was born in the 1970s (aged 35-44). By contrast, the relatively constant usage of the name Matt through time results in relatively consistent probabilities of the age of any particular Matt.

Returning to FIG. 2, the example data processing facility 106 is provided with the example age distribution generator 212 to generate the age distribution of a group of people whose names are known, such as the consumers 104 of one or more business establishment(s) 102. In some examples, the age distribution generator 212 generates such a distribution by aggregating or consolidating age probabilities corresponding to consumers 104 with particular names weighted based on how often each name occurs among the group of consumers 104 being analyzed.

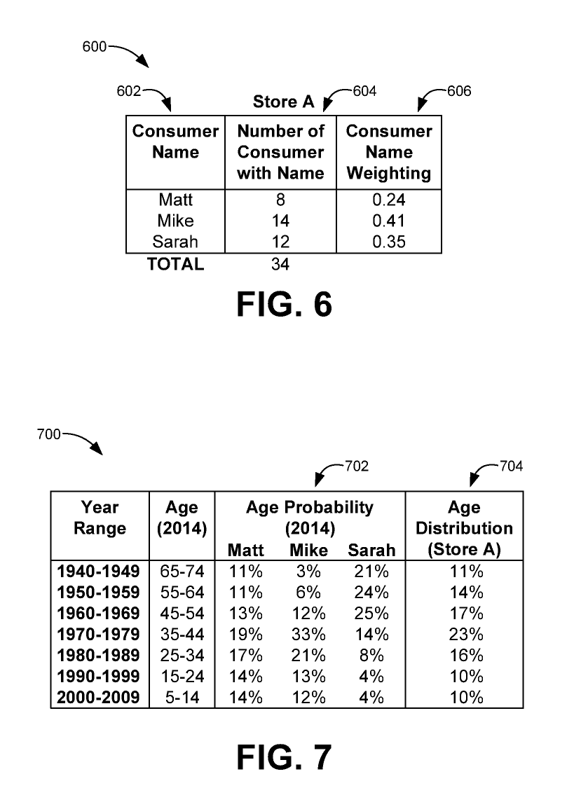

The process to calculate an age distribution is explained herein with reference to the illustrated examples of FIGS. 6-8 which continue from the specific example described above relating to FIGS. 3-5. In particular, FIG. 6 shows an example table 600 representing the names and numbers of consumers of a particular business establishment 102 identified as Store A. As shown in the illustrated example, a name column 602 indicates the names of consumers 104 of the store, which include Matt, Mike, and Sarah. A number of consumers column 604 indicates the number of consumers 104 making purchases or other transactions with Store A with the names designated in the first column 602. In some examples, each count for each name corresponds to every unique consumer 104. That is, repeat customers are only counted once. In other examples, each count for each name corresponds to every different transaction at Store A. That is, a single customer named Matt may have made purchases on three separate occasions resulting in the total number of consumers 104 named Matt being increased by three. In some examples, the number of consumers with the specified name may include consumers 104 that have names that are variants of the specific name identified (e.g., Mike may include consumers 104 named Michael).

In some examples, the number of consumers 104 identified in the second column 604 corresponds to a specific time period. For example, the table 600 may represent data collected over a week long period. Other examples may be based on other lengths of time (e.g., a single day, a part of a day, a month, etc.). Thus, in the illustrated examples, Store A transacted business with 8 consumers named Matt, 14 consumers named Mike, and 12 consumers named Sarah for a total of 34 consumers during the specified period.

In some examples, subsequent periods of time may be separately analyzed to compare with previous time periods to identify changes and/or trends in the age distribution of the business establishment(s) 102 over time. In other examples, data collected from subsequent periods of time may be aggregated or combined with previously collected data to update the analysis. In some such examples, the entire analysis described above may be repeated with the new cumulative data set. For example, the age distribution may be calculated for consumers 104 identified during a first week of time and then recalculated for a two week period of time including the first week and the following week once the data is obtained. For extended periods of time and/or for business establishment(s) 102 that have a large number of consumers 104, completely repeating the analysis based on an updated dataset can be time consuming and inefficient. Accordingly, in some examples, the age distribution generator 212 may model the age probabilities as a Dirichlet Distribution and update the numbers using Bayesian analysis and/or any other suitable statistical technique.

The example table 600 of FIG. 6 includes a weighting column 606 to indicate the relative weight of each name based on the number of consumers 104 with the corresponding name relative to the total number of consumers 104. That is, in the illustrated example, the age distribution generator 212 calculates the weighting for the name Matt by dividing the number of consumers 104 identified with the name Matt (8 in the illustrated example) with the total number of consumers 104 (34 in the illustrated example) to arrive at a weighting for the name Matt as observed at Store A (8/34=0.24).

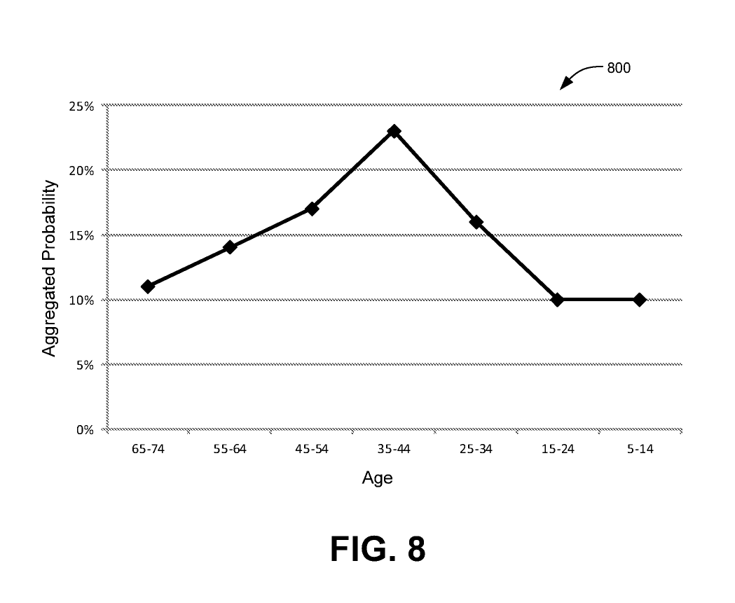

Using the weighting determined for each name, in the illustrated example, the age distribution generator 212 may calculate values for the age distribution of consumers 104 for Store A. FIG. 7 shows an example table 700 that represents these calculations. The example table 700 includes an age probability column 702, which is identical to the age probability column 312 of the example table 300 of FIG. 3. The calculated values for each decade and corresponding age range are represented in the age distribution column 704 of the example table 700. In the illustrated example, the age distribution is calculated as the sum of the products of the age probability for each name in a particular year range and the weighting for the corresponding name. Thus, the age distribution value for the 1940s is calculated as the age probability of the name Matt for that decade multiplied by the weighting for the name Matt observed in Store A plus the age probability of the name Mike multiplied by the weighting for the name Mike plus the age probability of the name Sarah multiplied by the weighting for the name Sarah resulting in the age distribution value of 11% ((11%×0.24)+(3%×0.41)+(21%×0.35)=3%+1%+7%). An example plot 800 of the estimated age distribution for Store A as represented in column 704 of the table 700 of FIG. 7 is illustrated in FIG. 8. As shown in the illustrated example, the highest proportion of consumers 104 at Store A are estimated to be between ages 35-44, which accounts for 23% of all Store A consumers. Further, 56% of the consumers 104 of Store A are between the ages of 25 and 54.

Although the illustrated example of FIGS. 3-8 is simplified for purposes of explanation by including year ranges or buckets of entire decades between 1940 and 2009, other examples may divide the data differently and/or include more ages (e.g., those born before 1940 and after 2009). For example, the age probabilities and corresponding age distribution for one or more business establishment(s) 102 may be calculated for each individual year or based on any other desired range. Further, in some examples, particular age ranges may be excluded from the analysis. For example, laws may proscribe the age at which a person may make a particular purchase (e.g., the legal age to purchase alcohol, the legal driving age limits those who make purchases at a drive-through, etc.) such that any person outside of the legally proscribed age range is assumed not to be a consumer. In other examples, business establishment(s) 102 may generally assume that none of their customers are under a particular age (e.g., 5 years old). In some such examples, the name usage data for the people with ages assumed not to be consumers 104 is omitted from the analysis. That is, in some examples, the name usage identifier 206 determines the popularity or frequency of use of particular names only in the years corresponding to people of a suitable age (e.g., the potential ages the consumers 104 are assumed to be). In some examples, this reduced dataset may impact the subsequent age probability calculations and the resulting age distribution calculations.

Additionally or alternatively, in some examples, the age distribution generator 212 generates the age distributions based on a subset of the consumers 104 associated with the business establishment(s) 102 for which consumer data was collected. In some examples, the age distribution generator 212 may identify a subset of the consumers 104 based on gender. That is, the age distribution generator 212, in some examples, calculates an age distribution based exclusively on the female names of the consumers 104 and/or exclusively based on the male names of the consumers 104.

In some examples, the age distribution generator 212 identifies a subset of the consumers 104 to serve as the basis of a particular age distribution based on factors identified in the purchasing data identified by the consumer data analyzer 204. For example, the subset of consumers 104 may be based on the particular product(s)/service(s) and/or type(s) of product(s)/service(s) purchased by the consumers 104. In this manner, the age distribution generator 212 can calculate the age distributions of different products or product types to identify whether there is a difference in appeal of such products to different age groups. In some examples, the subset of consumers 104 may be based on the method of payment used by the consumers 104. In this manner, for example, estimates of age demographics can be calculated for cash transactions, which are typically difficult to obtain (unlike credit card payments where user account information may be available with associated demographic information). In some examples, the subset of consumers 104 may be based on the time of day when purchases are made by the consumers 104. Additionally or alternatively, in some examples, the subset of consumers 104 may be based on the day of the week when purchases are made. In such examples, any difference in the age composition of the consumers 104 on different days (e.g., weekday vs. weekend) and/or at different times of the day (e.g., morning, afternoon, evening, late evening, etc.) may be identified. Analyzing subsets of consumers 104 in any of these or other manners is advantageous to identify distinctions in the age distributions generated based on different factors to assist in developing marketing and/or promotional campaigns more tailored to the key demographics involved and/or to target consumers 104 in age brackets outside of the key demographics to attract more of such consumers.

Additionally or alternatively, in some examples, a subset of the consumers 104 is identified for analysis based on the nature of the business establishment(s) 102 from which the consumer data is collected. For example, consumer data may be collected and aggregated from multiple business establishments 102. In some such examples, the different business establishments may correspond to different locations associated with a single company (e.g., individual franchises or chain stores). In some such examples, the data associated with consumers 104 from all such business establishments 102 may be analyzed collectively to estimate an overall age distribution of the parent company. Additionally or alternatively, in some examples, different subsets of the consumers 104 may be analyzed separately based on the location of the individual franchises or chain stores (e.g., individually or within a geographic region) with which the consumers 104 interacted. In some examples, the multiple business establishment(s) 102 from which the consumer data is collected may correspond to multiple unrelated businesses. In some such examples, age distributions may be generated for a particular type of business establishment (e.g., take-out restaurants, coffee shops, beauty salons, etc.). Thus, only a subset of the consumers 104 are analyzed corresponding to the consumers that have transacted business with the particular type of business. In some examples, a subset of consumers 104 may be identified based on the location or geographic location of the business establishments regardless of their type. The location may be a particular address (e.g., businesses within the same building), a street, a neighborhood, a commercial district, a city, a state, a country, or any other designated region. In this manner, the age distribution of consumers 104 within the particular location or region may be estimated and/or compared to other regions. In some examples, subsets of consumers 104 can be identified for analysis based on a combination of more than one of the factors identified above. For example, a subset of consumers 104 for which consumer data is collected may correspond to all consumers 104 that purchased a particular product from any of a number of business establishments in a particular geographic region.

In some examples, the age probability calculator 210 may use data from different birth name database(s) resulting in the age distribution generator 212 calculating different age distributions. As described above, while the SSA provides the usage of birth names across the entire United States, each of the states may include similar data specific to the particular state. Typically, the relative popularity or frequency of use of names in one state will differ somewhat from the usage of the name in other states. Accordingly, in some examples, the age probability calculator 210 may generate age probabilities for consumers 104 of a particular business establishment 102 based on the birth records of the state where the business establishment 102 is located. In this manner, the age distribution generator 212 can calculate a more particular age distribution of the consumers 104 if it can be assumed that most of the consumers 104 were born in the state (e.g., in smaller rural areas) rather than being visitors or having relocated from another state (e.g., in a metropolitan area where the is lots of transience). Of course, there is always likely to be some out-of-state consumers 104 at any particular business establishment. Accordingly, in some examples, the age distribution generator 212 generates an age distribution based on state-level data and a separate age distribution based on country-wide data for comparison.

In the illustrated example of FIG. 2, the data processing facility 106 is provided with the example historical trend analyzer 214 to analyze calculated age distributions over time. As described above, in some examples, the age distribution generator 212 generates age distributions corresponding to different points in time and/or updates the calculated distributions over time as additional data is obtained. In some such examples, the historical trend analyzer 214 analyzes the distributions to identify any changes or trends therein. Monitoring age distributions over time can provide valuable information to businesses and/or marketing entities. For example, consider an age distribution for a particular product calculated in 1990 that indicates the bulk of consumers 104 of the product are between the ages of 20 and 30. If the age distribution remains relatively constant over time (e.g., the age range between 20 and 30 remains the predominant age group purchasing the product), the historical trend analyzer 214 may determine that the particular product appeals to the predominant age bracket (20-30 year olds) independent of time. By contrast, if the age distribution for the same product is calculated in 2010 and the predominant age of consumers 104 is between 40 and 50 years old, the historical trend analyzer 214 may determine that the particular product appeals to a particular generation of consumers that age through time (e.g., due to brand loyalty). In some examples, an age distribution may be relatively flat or smooth (e.g., no predominant age of consumers). In some such examples, if the age distribution remains relatively flat over time, the historical trend analyzer 214 may determine that the consumer base for the particular product, service, brand, business, etc., is not significantly correlated to age (e.g., consumers 104 come from all ages over time).

In some examples, the consumer data collected by the consumer data collection interface 202 may include an indication of the age of the consumers 104 (e.g., where the age is provided as part of an application/reservation/order form or where the age is provided to qualify for the purchase of age restricted goods (e.g., cigarettes, alcohol, etc.)). In such examples, there is no need to analyze the consumer data to generate an age distribution to estimate the probable age demographics of the consumers 104. However, in some such examples, the given names of the consumers 104 and their corresponding age can be used to estimate the birthplace of the consumers 104. In the illustrated example of FIG. 2, the data processing facility 106 is provided with the example birthplace probability calculator 216 to calculate the probability of such consumers being born in a particular state. As described above, each state provides state-specific birth name data, which may be obtained by the name usage identifier 206. In some examples, the birthplace probability calculator 216 compares the number of people born with a particular name of a consumer 104 in the year corresponding to the birth year of the consumer 104 (determined from a known age) to determine the probability that the consumer was born in any particular state. For example, in 1975 there were approximately 700 people born in California that were given the name of Nathan while half that many were born in Texas in the same year. Thus, if a consumer 104 is identified as having the name of Nathan and is 39 years old in 2014 (born in 1975), the birthplace probability calculator 216 would determine that the consumer 104 is twice as likely to be from California as Texas. The above example assumes that the life expectancy of people from each of California and Texas are the same. However, in some examples, state-specific actuarial data may be used which may result in slightly different percentages depending upon the variation in survivorship of people from each state.

In some examples, the birthplace probability calculator 216 calculates the probability of the consumer 104 from each state to generate a distribution of birthplace probabilities across the United States for the particular consumer 104. More particularly, in some examples, the probability of a particular individual being born in a particular state is calculated by dividing the number of people born in the particular state in the same year as the individual and having the same name with the total number people born throughout the country. As indicated above, in some examples, differences in life expectancy between different states may be taken into account. In some examples, the total number of people born throughout the country is calculated based on a summation of the number from each state. In other examples, the total number is determined by referring to a national birth name database 110. In some examples, the birthplace probability calculator 216, combines or aggregates birthplace estimates of individual consumers 104 to generate a probability distribution of birthplaces of a group of consumers 104, such as, for example, those transacting business with the business establishment(s) 102.

In the illustrated example of FIG. 2, the data processing facility 106 is provided with the example database 218 to store the collected consumer data and information generated by the name usage identifier 206, the actuarial data analyzer 208, the age probability calculator 210, the age distribution generator 212, the historical trend analyzer 214, and/or the birthplace probability calculator 216. In some examples, the database 218 stores actuarial life tables that are referenced by the actuarial data analyzer 208 rather than obtaining such data from an external actuarial database 112. The example report generator 220 of FIG. 2 is provided to analyze the results of the above calculations and generate reports that may be provided to the business establishment(s) and/or other marketing entities. That is, the example report generator 220 may generate reports that include the age probabilities of particular names of the consumers 104, the age distribution(s) generated from such probabilities (e.g., an overall distribution and/or a factor-specific distribution), historical trend information, and/or birthplace estimates.

While an example manner of implementing the data processing facility 106 of FIG. 1 is illustrated in FIG. 2, one or more of the elements, processes and/or devices illustrated in FIG. 2 may be combined, divided, re-arranged, omitted, eliminated and/or implemented in any other way. Further, the example consumer data collection interface 202, the example consumer data analyzer 204, the example name usage identifier 206, the example actuarial data analyzer 208, the example age probability calculator 210, the example age distribution generator 212, the example historical trend analyzer 214, the example birthplace probability calculator 216, the example database 218, the example report generator 220, and/or, more generally, the example data processing facility 106 of FIG. 1 may be implemented by hardware, software, firmware and/or any combination of hardware, software and/or firmware. Thus, for example, any of the example consumer data collection interface 202, the example consumer data analyzer 204, the example name usage identifier 206, the example actuarial data analyzer 208, the example age probability calculator 210, the example age distribution generator 212, the example historical trend analyzer 214, the example birthplace probability calculator 216, the example database 218, the example report generator 220, and/or, more generally, the example data processing facility 106 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, consumer data collection interface 202, the example consumer data analyzer 204, the example name usage identifier 206, the example actuarial data analyzer 208, the example age probability calculator 210, the example age distribution generator 212, the example historical trend analyzer 214, the example birthplace probability calculator 216, the example database 218, and/or the example report generator 220 is/are hereby expressly defined to include a tangible computer readable storage device or storage disk such as a memory, a digital versatile disk (DVD), a compact disk (CD), a Blu-ray disk, etc. storing the software and/or firmware. Further still, the example data processing facility 106 of FIG. 1 may include one or more elements, processes and/or devices in addition to, or instead of, those illustrated in FIG. 2, and/or may include more than one of any or all of the illustrated elements, processes and devices.

Although the foregoing description of the data processing facility 106 of FIG. 2 has been described as being implemented by the market research entity 108, in some examples, the data processing facility 106 or portions thereof may alternatively be implemented by other entities. For example, some or all of the components of the data processing facility 106 may be implemented by a business establishment 102 without reliance on a third party market research entity 108.

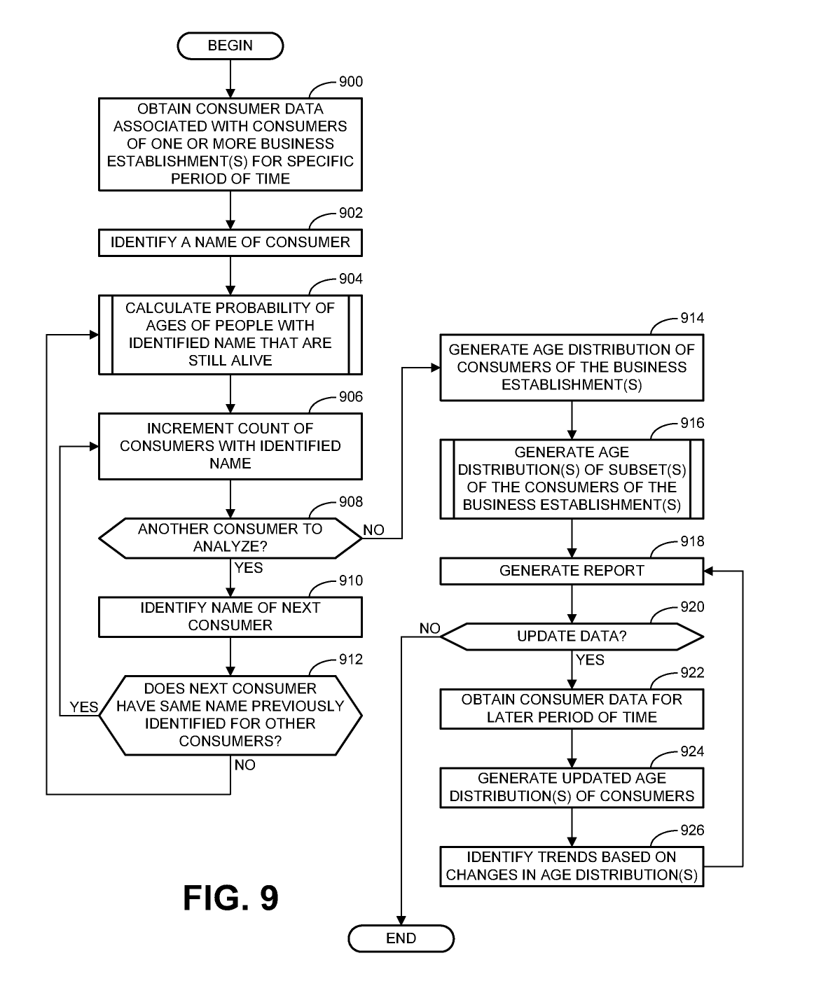

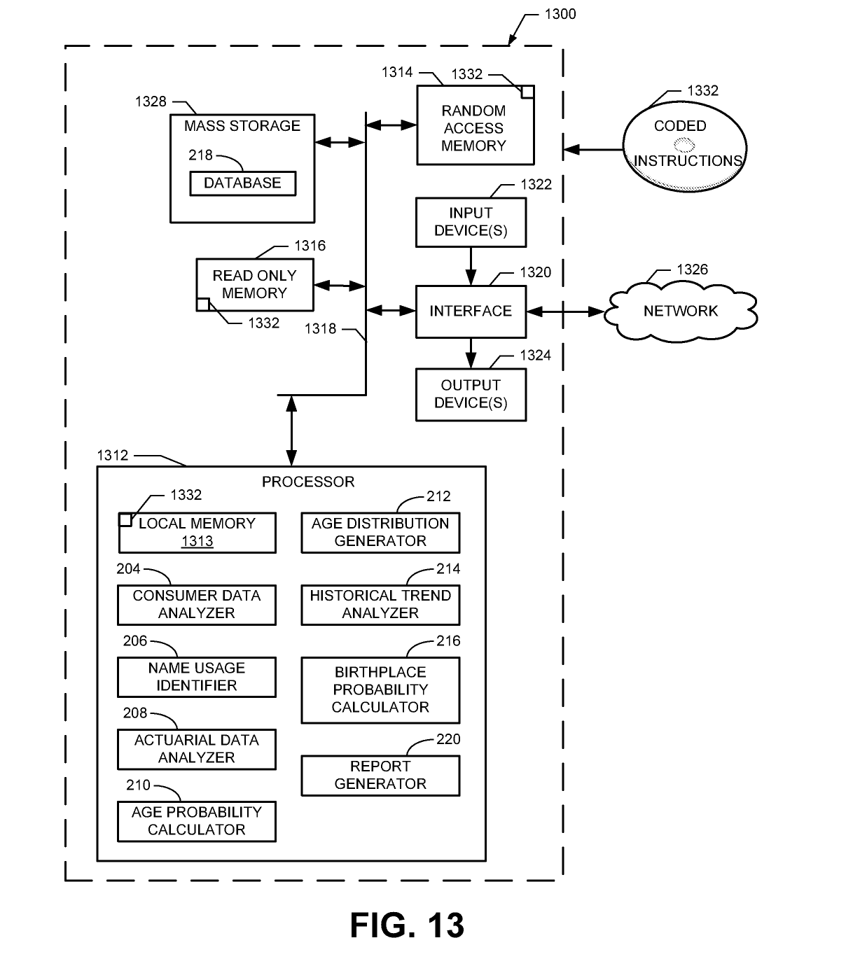

Flowcharts representative of example machine readable instructions for implementing the example data processing facility 116 of FIGS. 1 and/or 2 is shown in FIGS. 9-12. In this example, the machine readable instructions comprise a program for execution by a processor such as the processor 1312 shown in the example processor platform 1300 discussed below in connection with FIG. 13. The program may be embodied in software stored on a tangible computer readable storage medium such as a CD-ROM, a floppy disk, a hard drive, a digital versatile disk (DVD), a Blu-ray disk, or a memory associated with the processor 1313, but the entire program and/or parts thereof could alternatively be executed by a device other than the processor 1312 and/or embodied in firmware or dedicated hardware. Further, although the example program is described with reference to the flowcharts illustrated in FIGS. 9-12, many other methods of implementing the example data processing facility 116 may alternatively be used. For example, the order of execution of the blocks may be changed, and/or some of the blocks described may be changed, eliminated, or combined.

As mentioned above, the example processes of FIGS. 9-12 be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 9-12 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

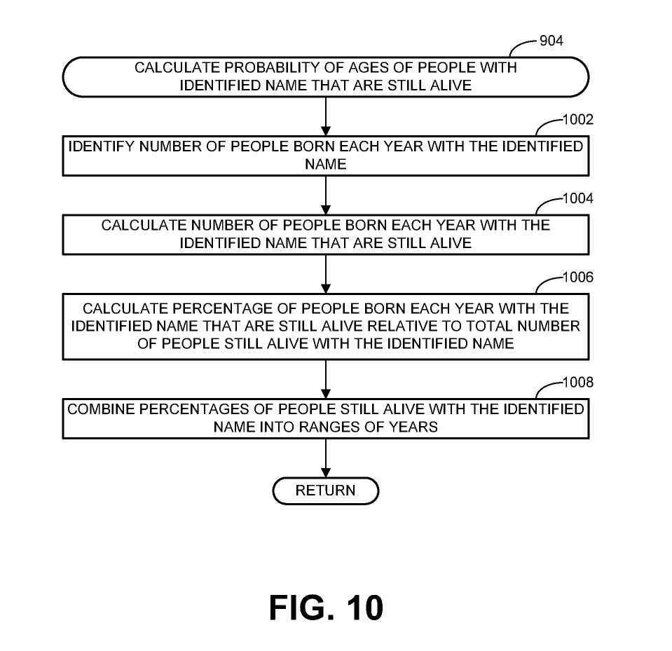

The program of FIG. 9 begins at block 900 where the example consumer data collection interface obtains consumer data associated with consumers 104 of one or more business establishment(s) 102 over a specific period of time. In some examples, the consumer data includes the given names of consumers 104 doing business with one or more business establishments 102. In some examples, the consumer data includes purchasing data associated with the transactions entered into by the consumers 104. The specific period of time over which the consumer data is collected may be of any suitable length to include a sufficient number of transactions with different consumers. For example, the period may be several months, one month, a week, a day, or a part of a day. At block 902 the example consumer data analyzer 204 identifies a name of one of the consumers 104. At block 904, the example age probability calculator 210 calculates the probability of ages of people with the identified name that are still alive. Further detail concerning the implementation of block 904 is described below in connection with FIG. 10.

At block 906, the age distribution generator 212 increments a count of consumers 104 with the identified name. That is, if the particular name identified is the first instance of that name, the count is set to one. If the same name has already been identified for previous consumers 104, the count is correspondingly incremented. In some examples, different names that are variants of each other may be treated as the same name and, therefore, combined for purposes of counting.

At block 908, the example consumer data analyzer 204 determines whether there is another consumer to analyze. If so, control advances to block 910 where the example consumer data analyzer 204 identifies a name of the next consumer 104. At block 912, the age distribution generator 212 determines whether the next consumer 104 has the same name previously identified for other consumers 104. If the name of the next consumer 104 is not the same as previously identified names, control returns to block 904 to calculate the probability of ages of people with the name of the next consumer 104. However, if the name of the next consumer 104 is the same as previously identified names, the analysis of block 904 has already been performed. Accordingly, control advances to block 906 to increment the count of consumers 104 with the same name. Returning to block 908, if the consumer data analyzer 204 determines there are no other consumers to analyze, control advances to block 914.

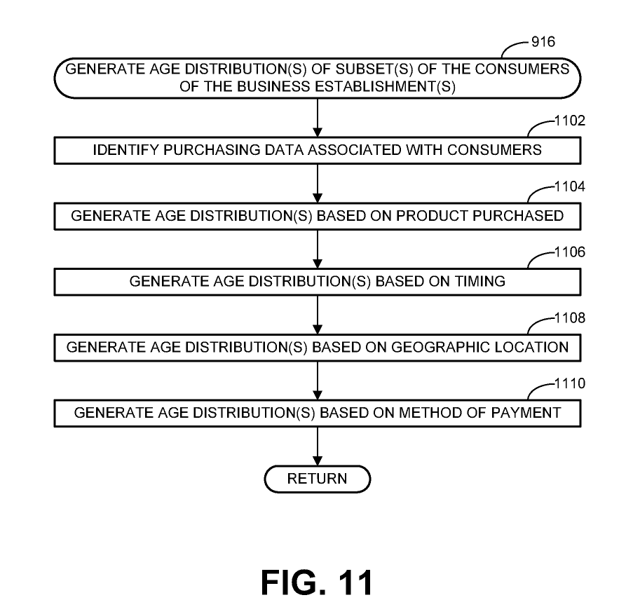

At block 914, the example age distribution generator 212 generates an age distribution of the consumers 104 of the business establishment(s) 102. In some examples, the age distribution is generated based on the sum of the products of the age probability of each identified consumer name and the weighting of each name (based on the count of the name relative to the total number of consumers). In some examples, these calculations are performed for each year. In some examples, multiple years are combined into year ranges. At block 916, the example age distribution generator 212 calculates age distribution(s) of subset(s) of the consumers 104 of the business establishment(s) 102. Further detail concerning the implementation of block 916 is described below in connection with FIG. 11.

At block 918, the example report generator 220 generates a report. At block 920, the example consumer data analyzer 204 determines whether to update the data. If so, control advances to block 922 where the example consumer data collection interface obtains consumer data for a later period of time. In some examples, the later of period of time may be the same length as the specific period of time described in connection with block 900. In other examples, the later period of time may be a shorter or longer period of time. At block 924, the example age distribution generator 212 generates updated age distribution(s) of the consumers 104. In some examples, the updated age distribution(s) are generated using the same method as the initial aggregated age distribution generated at block 914. In other examples, the updated age distribution(s) are generated using the Dirichlet multinomial model in Bayesian analysis and/or any other suitable statistical technique. At block 926, the example historical trend analyzer 214 identifies trends based on the changes in the age distribution(s). Control then returns to block 918 to generate an updated report. If the example consumer data analyzer 204 determines not to update the data (block 920), the example program of FIG. 9 ends.

FIG. 10 is a flowchart representative of example machine readable instructions that may be executed to implement block 904 of the example program of FIG. 9. The example of FIG. 10 begins at block 1002 where the example name usage identifier 206 identifies the number of people born each year with the identified name (identified at blocks 902 or 910 of FIG. 9). In some examples, the years considered include every year that data is available. However, the birth name database maintained by the SSA goes back to 1880, which is further in the past than the year of birth of anyone now living. Thus, in some examples, the years considered include every year that data is available up to a defined limit before which few if any people then born would still be alive (e.g., 115 years, 120, years). Further, in some examples, the most recent years of available data may also be excluded if all consumers 104 are assumed to be above a certain age (e.g., legal driving age, legal drinking age, etc.)

At block 1004, the example age probability calculator 210 calculates the number of people born in each year with the identified name that are still alive. In some examples, the number of people still alive is calculated based on the number of people born each year (determined at block 1002) multiplied by the percentage estimated to still be living based on actuarial data determined by the actuarial data analyzer 208. At block 1006, the example age probability calculator 210 calculates the percentage of the people born each year with the identified name that are still alive relative to the total number of people still alive with the identified name. In some examples, the percentage for a particular year is calculated by dividing the number of people born in the particular year that are still alive by the cumulative total of people still alive from every year. In some examples, at block 1008, the example age probability calculator 210 combines the percentage of people still alive with the identified name into ranges of years. That is, rather than keeping every year separate, the example age probability calculator 210 may combine multiple years together. The example of FIG. 10 then ends and returns to the example of FIG. 9.

FIG. 11 is a flowchart representative of example machine readable instructions that may be executed to implement block 916 of the example program of FIG. 9. The example of FIG. 11 begins at block 1102 where the example consumer data analyzer 204 identifies purchasing data associated with the consumers 104. In some examples, the purchasing data includes information about the transactions associated with the names of the consumers 104 identified at blocks 902 and 910 of the example of FIG. 9. For example, the purchasing data includes information about the products or services and corresponding brands purchased, information about the timing of purchases, information about the location of purchases (e.g., the location of the business establishment and/or location of the consumer at the time of purchase), information about the method of payment, information about the business establishment(s) from which the data was obtained (e.g., location, type, relationship to other businesses, etc.), and so forth.

At block 1104, the example age distribution generator 212 generates age distribution(s) based on the products purchased. For example, the age distribution generator 212 may generate an age distribution for a particular product or type of product. In such examples, only the consumers 104 that purchased such product or type of product would be included in the analysis while other consumers 104 would be excluded.

At block 1106, the example age distribution generator 212 generates age distribution(s) based on timing. For example, the age distribution generator 212 may generate separate age distributions for purchases made in the morning and purchases made in the evening. In other examples, the age distribution generator 212 may generate an age distribution for purchases made on a Sunday, a weekend, or a Friday evening, etc. Accordingly, the subset of consumers 104 analyzed in such distributions is limited to the consumers 104 that made purchases during the times of interest.

At block 1108, the example age distribution generator 212 generates age distribution(s) based on geographic location. In some examples, a particular geographic location is defined based on the location of the business establishments 102 from which the consumer data is obtained. For example, a particular geographic location may correspond to a particular building, street, neighborhood, commercial district, city, state, or any other region. In some examples, the age distribution is based on consumer data from multiple different businesses in the same geographic location. In other examples, the age distribution is based on consumer data obtained from multiple different business locations associated with same company (e.g., different franchises or chain stores). Accordingly, the subset of consumers 104 analyzed depends upon the geographic division being applied and the nature of the business establishment(s) 102 from which the consumer data was originally obtained

At block 1110, the example age distribution generator 212 generates age distribution(s) based on method of payment. For example, the age distribution generator 212 may generate an age distribution specifically for purchases made with cash. Accordingly, the subset of consumers 104 would only correspond to those consumers associated with cash transactions.

In the illustrated example of FIG. 11, each of blocks 1104, 1106, 1108, and 1110 may be independently implemented without the others. That is, in some examples, only some of blocks 1104, 1106, 1108, and 1110 are implemented while the others are omitted. Further, in some examples, the factors used to identify the subset of consumers 104 in each of the blocks 1104, 1106, 1108, and 1110 may be combined to generate more specific age distribution(s). For example, the age distribution generator 212 may generate an age distribution corresponding to a particular product purchased by consumers on a particular day within a particular geographic region. After calculating the desired age distribution(s), the example of FIG. 11 ends and returns to the example of FIG. 9.

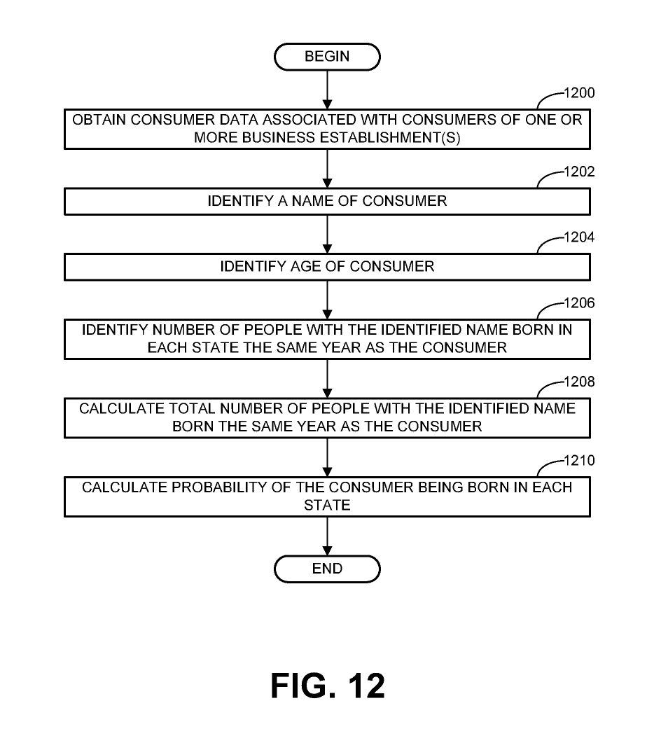

The example program of FIG. 12 begins at block 1200 where the example consumer data collection interface 202 obtains consumer data associated with consumers 104 of one or more business establishment(s) 102. At block 1202, the example consumer data analyzer 204 identifies a name of a consumer 104. At block 1204, the example consumer data analyzer 204 identifies an age of a consumer 104. In some examples, the name and age of the consumer 104 are identified from the consumer data. That is, in some examples, consumers 104 may provide their name and age as part of a transaction with a business (e.g., in filling out a form or to qualify for age restricted products or services) that is included in the collected consumer data. At block 1206, the example name usage identifier 206 identifies the number of people with the identified name born in each state the same year as the consumer 104. In such examples, the name usage identifier 206 may access state birth name databases 110 rather than a national birth name database 110.

At block 1208, the example birthplace probability calculator 216 calculates the total number of people with the identified name born the same year as the consumer 104. In some examples, the total number of people is calculated by the summation of the number identified for each state (determined at block 1206). In other examples, the total number of people may be determined based on reference to the national birth name database 110. At block 1210, the example birthplace probability calculator 216 calculates the probability of the consumer being born in each state, after which the example program of FIG. 12 ends.

FIG. 13 is a block diagram of an example processor platform 1300 capable of executing the instructions of FIGS. 9-12 to implement the data processing facility 116 of FIGS. 1 and/or 2. The processor platform 1300 can be, for example, a server, a personal computer, a mobile device (e.g., a cell phone, a smart phone, a tablet such as an iPad™), a personal digital assistant (PDA), an Internet appliance, or any other type of computing device.

The processor platform 1300 of the illustrated example includes a processor 1313. The processor 1312 of the illustrated example is hardware. For example, the processor 1312 can be implemented by one or more integrated circuits, logic circuits, microprocessors or controllers from any desired family or manufacturer.

The processor 1312 of the illustrated example includes a local memory 1312 (e.g., a cache). In the illustrated example, the processor 1312 implements the example consumer data analyzer 204, the example name usage identifier 206, the example actuarial data analyzer 208, the example age probability calculator 210, the example age distribution generator 212, the example historical trend analyzer 214, the example birthplace probability calculator 216, and/or the example report generator 220 of FIG. 2. The processor 1312 of the illustrated example is in communication with a main memory including a volatile memory 1314 and a non-volatile memory 1316 via a bus 1318. The volatile memory 1314 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1316 may be implemented by flash memory and/or any other desired type of memory device. Access to the main memory 1314, 1316 is controlled by a memory controller.

The processor platform 1300 of the illustrated example also includes an interface circuit 1320. The interface circuit 1320 may be implemented by any type of interface standard, such as an Ethernet interface, a universal serial bus (USB), and/or a PCI express interface.

In the illustrated example, one or more input devices 1322 are connected to the interface circuit 1320. The input device(s) 1322 permit(s) a user to enter data and commands into the processor 1313. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1324 are also connected to the interface circuit 1320 of the illustrated example. The output devices 1324 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1320 of the illustrated example, thus, typically includes a graphics driver card, a graphics driver chip or a graphics driver processor.

The interface circuit 1320 of the illustrated example also includes a communication device such as a transmitter, a receiver, a transceiver, a modem and/or network interface card to facilitate exchange of data with external machines (e.g., computing devices of any kind) via a network 1326 (e.g., an Ethernet connection, a digital subscriber line (DSL), a telephone line, coaxial cable, a cellular telephone system, etc.).

The processor platform 1300 of the illustrated example also includes one or more mass storage devices 1328 for storing software and/or data. For example, the mass storage device 1328 may include the example database 218 of FIG. 2. Examples of such mass storage devices 1328 include floppy disk drives, hard drive disks, compact disk drives, Blu-ray disk drives, RAID systems, and digital versatile disk (DVD) drives.

The coded instructions 1332 of FIGS. 9-12 may be stored in the mass storage device 1328, in the volatile memory 1314, in the non-volatile memory 1316, and/or on a removable tangible computer readable storage medium such as a CD or DVD.

From the foregoing, it will be appreciated that the above disclosed methods, apparatus and articles of manufacture enable the generation of demographic information about consumers that may not otherwise be available. In particular, the examples disclosed herein enable the estimation of the ages of consumers based on no other information than their given names. By aggregating such estimates for an entire group of consumers such as, for example, the consumers transacting business with one or more particular business establishments, age demographics for those business establishments in the form of estimated age distributions can be generated. Such demographic information has significant practical benefits to such business establishment(s) to enable them to plan more efficient and/or effective marketing endeavors. Furthermore, the examples disclosed herein can generate age distributions for particular products, types of products, and/or brands purchased, particular times of such purchases, particular methods of payment for such purchases, particular geographic locations of such purchases to further assist business establishment(s) and/or other marketing entities in understanding the demographics of the consumers with which they interact and/or are targeting.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. A method comprising:
obtaining names of consumers associated with a business establishment;
determining, with a processor, age probabilities of the consumers based on different ones of the names of the consumers; and
generating, with the processor, an age distribution of the consumers based on the age probabilities.

2. The method of claim 1, further comprising weighting the names of the consumers based on a number of consumers associated with a same name, the age distribution based on the weighting of the names.

3. The method of claim 1, further comprising:
obtaining purchasing data associated with each of the consumers, the purchasing data comprising information indicative of factors associated with transactions made by the consumers with the business establishment;
identifying a subset of the consumers based on the purchasing data; and
generating a factor-specific age distribution of the subset of the consumers.

4. The method of claim 3, further comprising identifying the subset of the consumers based on products purchased by the consumers indicated by the purchasing data, the subset of the consumers corresponding to consumers that purchased at least one of a target product, a target type of product, or a target brand of product.

5. The method of claim 3, further comprising identifying the subset of the consumers based on a timing of purchases made by the consumers indicated by the purchasing data.

6. The method of claim 5, wherein the subset of the consumers corresponds to consumers that made a purchase at a target time of day.

7. The method of claim 5, wherein the subset of the consumers corresponds to consumers that made a purchase on a target day of a week.

8. The method of claim 3, further comprising identifying the subset of the consumers based on a method of payment used for purchases made by the consumers indicated by the purchasing data.

9. The method of claim 8, wherein the subset of the consumers corresponds to consumers that used cash to pay for a purchase.

10. The method of claim 3, further comprising identifying the subset of the consumers based on a geographic location of purchases made by the consumers indicated by the purchasing data.

11. The method of claim 1, further comprising:
obtaining other names of other consumers associated with other business establishments; and
generating the age distribution based on the other names of the other consumers.

12. The method of claim 11, wherein the business establishment and the other business establishments correspond to different locations of a common company.

13. The method of claim 11, wherein the business establishment and the other business establishments correspond to different companies.

14. The method of claim 13, wherein the business establishment and the other business establishments are located at a common geographic location comprising at least one of an address, a street, a neighborhood, a commercial district, or a city.

15. An apparatus, comprising:
an age probability calculator to calculate probabilities of ages of consumers associated with a business establishment, the probabilities of ages determined based on names of the consumers; and
an age distribution generator to generate an age distribution of the consumers based on the probabilities of ages of the consumers.

16. The apparatus of claim 15, wherein the age distribution generator is to weight the names of the consumers based on a number of consumers associated with a same name, the age distribution based on the weight of the names.

17. The apparatus of claim 15, further comprising:
a consumer data collection interface to obtain purchasing data associated with each of the consumers, the purchasing data comprising information indicative of factors associated with transactions made by the consumers with the business establishment; and
a consumer data analyzer to identify a subset of the consumers based on the purchasing data, the age distribution generator to generate a factor-specific age distribution of the subset of the consumers.

18.-27. (canceled)

28. A tangible computer readable storage medium having instructions that, when executed, cause a machine to at least:
obtain names of consumers associated with a business establishment;
determine age probabilities of the consumers based on different ones of the names of the consumers; and
generate an age distribution of the consumers based on the age probabilities.

29. The tangible computer readable storage medium of claim 28, wherein the instructions further cause the machine to weight the names of the consumers based on a number of consumers associated with a same name, the age distribution based on the weighting of the names.

30. The tangible computer readable storage medium of claim 28, wherein the instructions further cause the machine to:
obtain purchasing data associated with each of the consumers, the purchasing data comprising information indicative of factors associated with transactions made by the consumers with the business establishment;
identify a subset of the consumers based on the purchasing data; and
generate a factor-specific age distribution of the subset of the consumers.

31.-40. (canceled)
